(19) United States
(12) Patent Application Publication
(10) Pub. No.: US 2007/0251655 A1
(43) Pub. Date: Nov. 1, 2007

(54) Unadorned arched window corering

(76) Inventor: Mahmoud Aliasgarian, Windsor (CA)

Correspondence Address: Mahmoud Aliasgarian, 435 Hamner Cir., Windsor, ON, N9E 4P8, CA

(21) Appl. No.: 11/412,449

(22) Filed: Apr. 27, 2006

(51) Int. Cl. E06B 9/24

(52) U.S. Cl. 160/371

(57) ABSTRACT

A fan-like window covering made of fabric used to cover arched windows comprises only a frame and a single piece curtain. The frame is constructed from a metal rod formed to the shape of the window and then cut in two parts. Spread shape of a curtain that has desired creases and is continuous over the surface of the window covering frame area, is simulated over a drawing table to be used as a model for cutting a blank fabric. The cut fabric is then sewed to form a curtain having a passageway along the entire perimeter to pull over said frame. Predefined side of the curtain is gathered over the smaller part of the frame that is located at the mid lower side to form the source of the creases, while other sides are expanded over the rest part of the frame to create suitable folds and then two parts of the frame are connected to form an unadorned arched window covering.

### BACKGROUND AND SUMMARY OF THE INVENTION

The present invention generally relates to the field of curtains and draperies for residential homes and particularly to the architectural windows. Some entrance doors and/or regular rectangular windows have at the upper side an arched window portion and also there are windows that are entirely circular or ellipsoidal.

The above mentioned arched window portion can be of any shape such as a semicircle, a semi-ellipsoid, two adjacent quarter circles or quarter ellipsoids, two connected arched segments with a base and a composition of one arch followed by two vertical short sides with a base. Arched windows are generally decorative and are considered as part of home decoration. Similar to any regular window also architectural windows need to be covered by suitably designed window covering that is match-able to the regular curtains in the building, moreover providing privacy, gently filtering the sunlight entering the building and creating a dramatic look of the building interior and exterior. At the same time a window covering should not conceal the beauty involved in the design of the architectural windows and in fact it should add to that.

Previously, fan-like window treatments and curtains for irregular shaped windows that are made out of fabric have suffered from an important deficiency, as the curtain, either is not continuous over the frame area or does not cover the entire surface area of the respective frame. In the some cases there is excess fabric that needs to be gathered on a cord at the center of the frame of the window treatment and in some other cases an opening is formed on the surface of the curtain at the center of the frame. In both cases said central node and/or opening further needs to be covered or filled by ornamental pieces, as illustrated in the U.S. Pat. Nos. 5,044,418, 5,219,407, 5,765,619 and 5,063,985. Said ornamental pieces together with the bushy creases around said node and/or opening causes several disadvantages as are described hereunder:
Make a substantial portion of the curtain area impenetrable to day light, creating a dark area on the surface of the curtain that prevents the sun light to enter the building neither sufficiently nor uniformly, comparing adjacent regular curtains.
Conceals the beauty of the architectural windows.
Make matching the window covering to the regular curtains in the building difficult.
Make disassembling and reassembling of the window covering difficult, especially if said ornamental pieces are to be scattered for washing.

The present invention relates to a specific method of designing and modeling a fabric for making a curtain that solely covers 100% of the surface area of the window covering frame. Whereas window covering of the present invention consists of only a frame and a single piece curtain

Frame is constructed from a metal rod and formed to the shape of the window then divided in two separate parts. Curtain is constructed from one single piece of fabric, cut in a special design, said special design is based on the spread shape of a curtain that has predefined creases and is continuous over the entire surface of the window covering frame area and then the cut fabric is sewed to have a passageway along its entire perimeter to pull over said frame. Whereas one predefined side of said curtain is pulled and gathered over one small portion of the frame that is located at mid lower side of said frame to form the source or the creases of the window covering, other sides of the curtain are pulled and expanded over second part of the frame and then said two parts of the frame are connected to each other. Creases that are originated at said small portion of the frame are extended towards the opposite sides of the frame where said creases are ended, whereas a complete window covering having a continuous curtain with suitable creases is created. As a result the present invention removes the above said deficiencies and introduces more advantages as are described in below:
Entire surface of the curtain is penetrable to day light, therefore allows the window behind the window covering being visible, which adds to the beauty of the architectural windows.
Less amount of fabric is used, because curtain has a length equal to the perimeter of the curved portions of the frame, whereas the known art uses fabric with 2.25 times the length of the radial portion of the frame, therefore the present method of fabricating an arched window covering is more economical, as the fabric cost reduces by about 45%.
Measuring, modeling and cutting the fabric according to the present invention comparing to the prior art requires specialty and precision, however sewing the curtain and assembling the window covering of the present invention is much easier and faster.
Window covering of the present invention has two similar or identical sides, (based on the fabric used) therefore it can be turned over desired.
The same method of fabrication is applicable to various shapes of architectural windows.

### BRIEF DESCRIPTION OF THE DRAWINGS

FIG. 1: is perspective view of a sample arched window covering of the present invention mounted onto the respective arched window;

FIGS. 2A to 2G: are typical top views of the alternate shapes of the arched window coverings of the present invention;

FIGS. 3A to 3G: are typical top views of the frames for the window coverings of the FIGS. 2A to 2G, based on the present invention;

FIGS. 4A to 4G: are sketches simulating the real size frames as are typically shown in the FIGS. 3A to 3G;

FIGS. 5A to 5G: are sketches showing the simulated shapes of the spread curtains. Each sketch is related to the sketch of the respective frame as shown in the FIGS. 4A to 4G;

FIG. 6: is a sample showing the same sketch of FIG. 5G expanded about 1 inch from each side to simulate the shape of the cut fabric;

FIG. 7: is a sample curtain made by sewing the cut fabric of the FIG. 6;

FIG. 8: is cross-section A-A of the curtain of FIG. 7, showing the details of how the fabric is sewed;

FIGS. 9A to 9G: showing the alternate shapes of the spread curtains related to the window coverings of FIGS. 2A to 2G;

FIG. 10: is the sample frame of the FIG. 3A separated into curtain rod and crease holder parts;

FIG. 11: showing the same curtain of the FIG. 9A pulled over the curtain rod of the FIG. 10 from its straight sides while the crease holder is going to be inserted into the passageway of the curved side of said curtain;

FIG. 12: showing the crease holder completely entered into the curved side of the curtain while said side gathered over the crease holder and said crease holder connected to the curtain rod using two connecting tubes;

FIG. 13: is detail B of the FIG. 12 to show connection joints of the curtain rod and the crease holder;

FIG. 14: is a sample showing the approximate location area “C” for attaching the window covering holders into the window frame;

FIG. 15: is cross-section D-D of the window and the window covering of the FIG. 14 showing the locations of attaching the window covering and the window covering holders into the window frame;

FIG. 16: is detail C of the FIGS. 14 & 15 to show the way of attaching window covering holders into the window frame.

### DETAILED DESCRIPTION OF THE INVENTION

Arched windows come in a variety of shapes and sizes. Present invention is a method to make specific window coverings for any shape of an architectural window that comprises at least an arched portion.

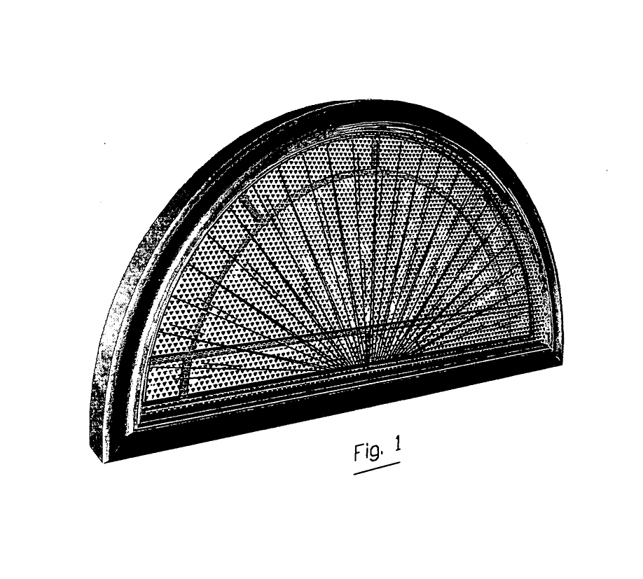

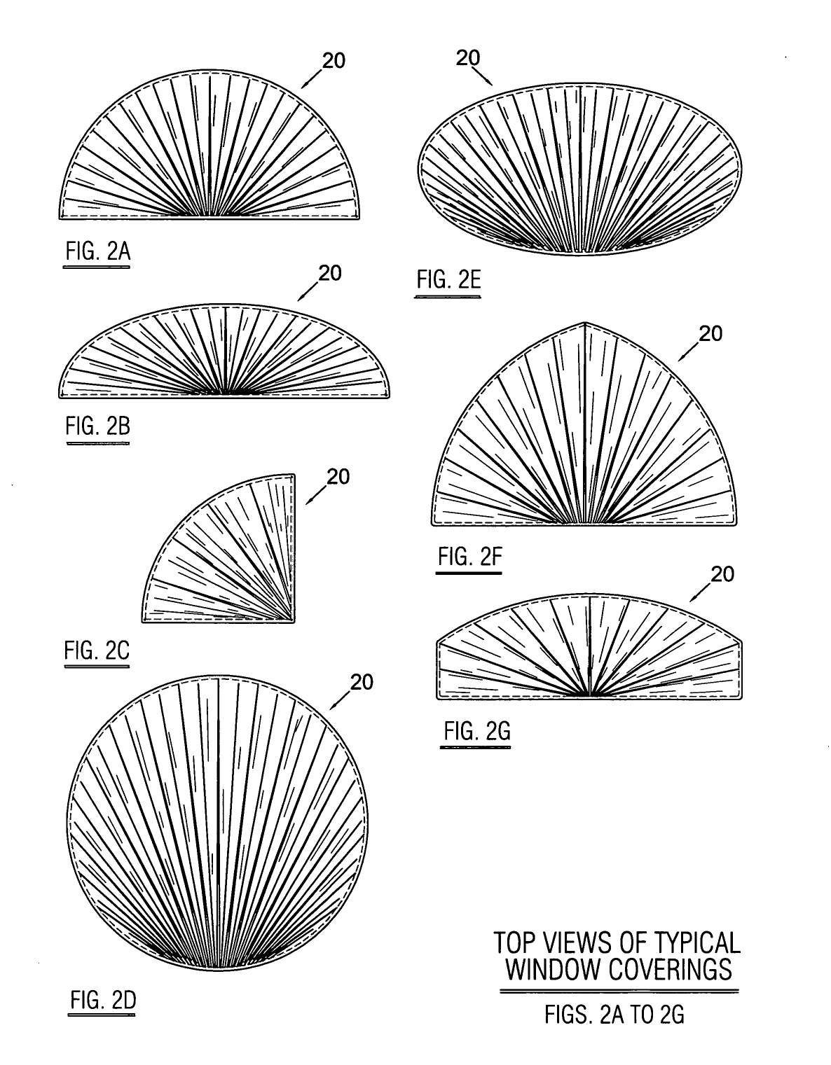

Perspective view of a sample arched window and its respective window covering of the present invention is shown in FIG. 1, and typical top views of the alternate shapes of the window covering 20 covered by the present invention are shown in the FIGS. 2A to 2G.

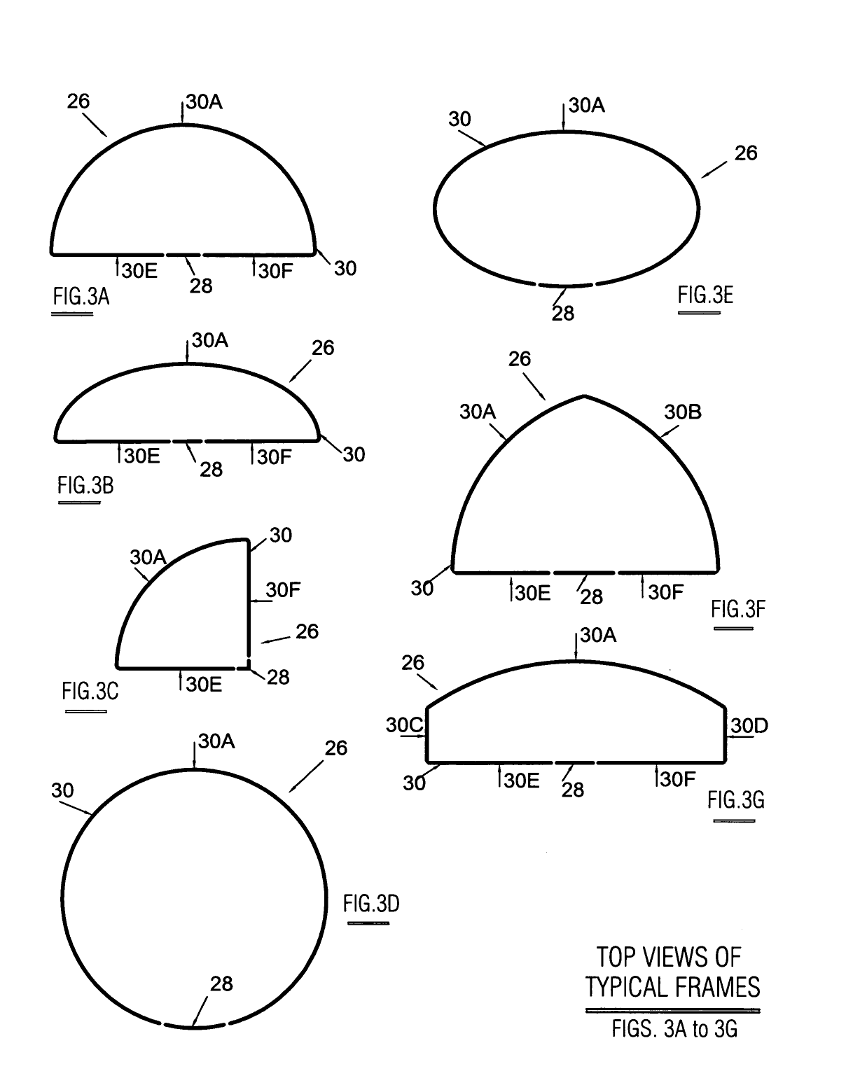

Each window covering of the present invention consists of a frame and a single piece curtain. Alternate shapes of the frames 26 related to the window coverings 20 are shown in the FIGS. 3A to 3G. Frame 26 is composed of two separate parts, Crease holder 28 and Curtain rod 30. Crease holder 28, is a small part (as defined later in this section) of the frame 26 that in the preferred embodiment is located at the mid lower side of said frame and is a straight piece as part of the base in the cases of non full curved shapes FIGS. 3A, 3B, 3F and 3G, a straight or symmetric broken piece in the cases of quarter circle (FIG. 3C) or quarter ellipse, and an curved piece as part of the full curve in the cases of full circular or full ellipsoidal shapes (FIGS. 3D and 3E).

The curtain rod 30 of the present invention may generally have curved, straight and base portions as described hereunder:

Curve may consist of one portion 30A (FIGS. 3A, 3B, 3C, 3D, 3E and 3G) or two identical portions 30A and 30B (FIG. 3F). Curved portion 30A may be followed by two identical short (as defined later in this section) vertical sides 30C and 30D (FIG. 3G) and only in the cases of non full curved shapes (FIGS. 3A, 3B, 3C, 3F, and 3G), two other straight portions 30E and 30F together with the crease holder 28 make the base of the frame.

Length d of the crease holder is a ratio of the perimeter p of the curved portion(s) of the curtain rod, and it is experimentally determined to be d=0.125p in the cases of non full curved shapes and d=0.145p in the cases of full curved shapes. These formulas give the length of the crease holder in the case of using fabric with medium thickness (lace curtains or Sheers), for thinner or thicker fabrics up to 10% is deducted or added to the calculated length. The same length d will become the source of the creases of the curtains of the present invention.

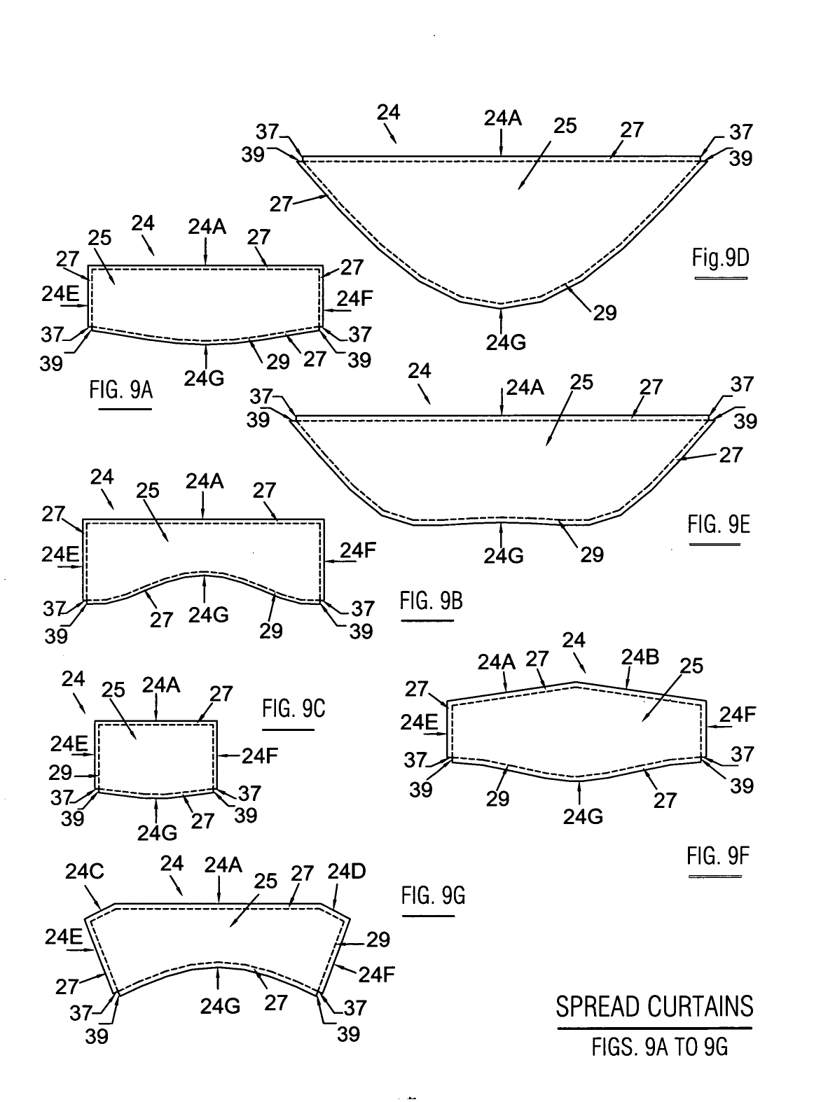

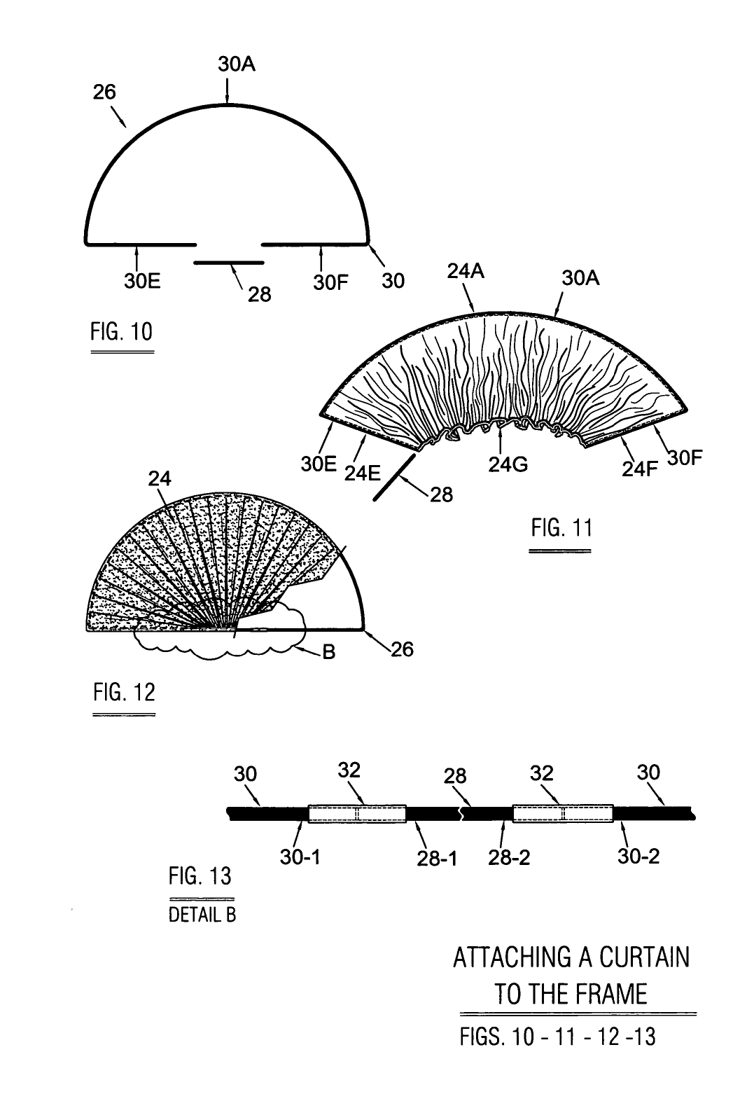

Method of making the window coverings 20 as are typically shown in the FIGS. 2A to 2G is based on simulating the shapes of the spread curtains 24 of the window coverings as shown in the FIGS. 9A to 9G and to obtain a model for cutting a blank fabric so that if sewed according to the instruction described hereunder and attached to the respective frame covers the entire surface area of the frame without discontinuity and create a complete arched window covering.

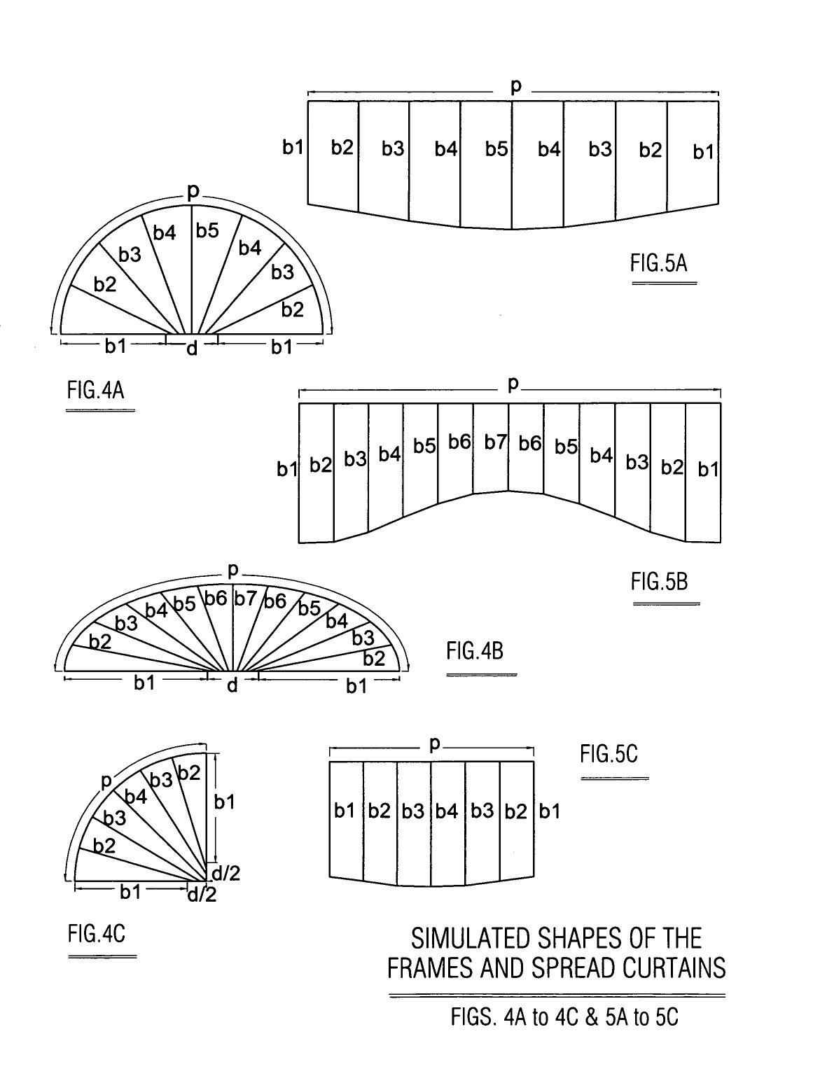

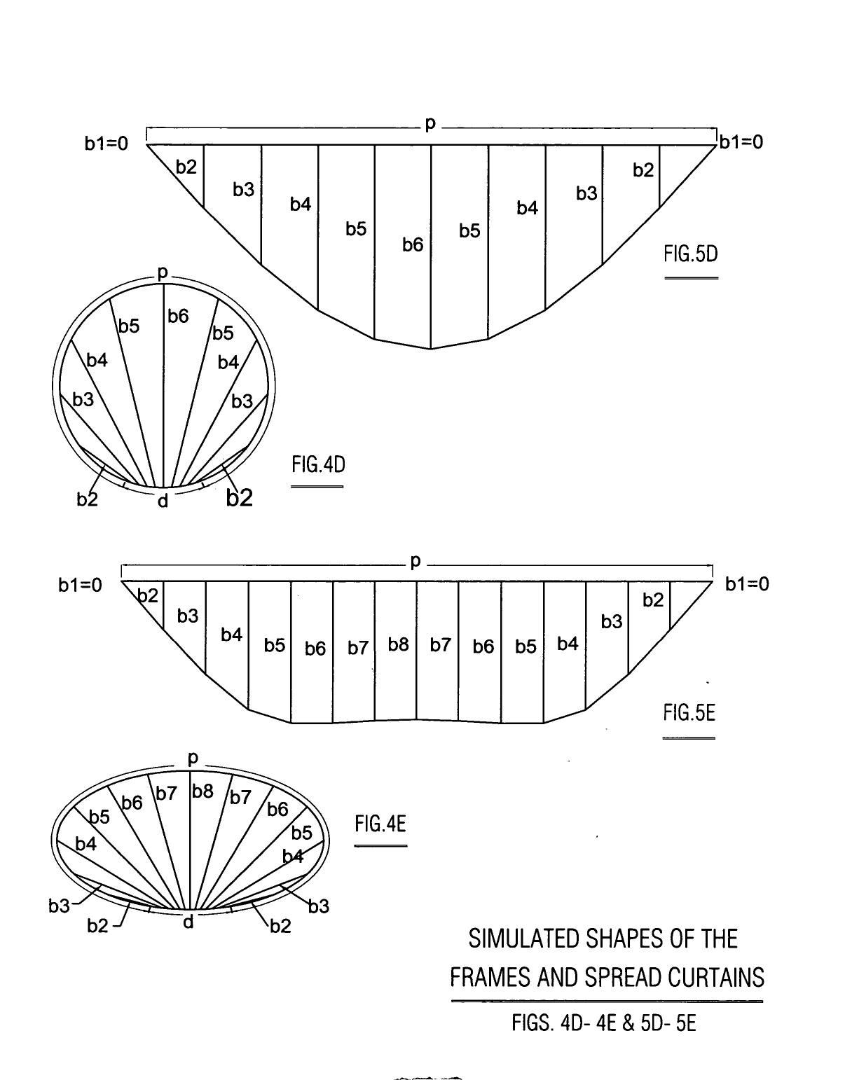

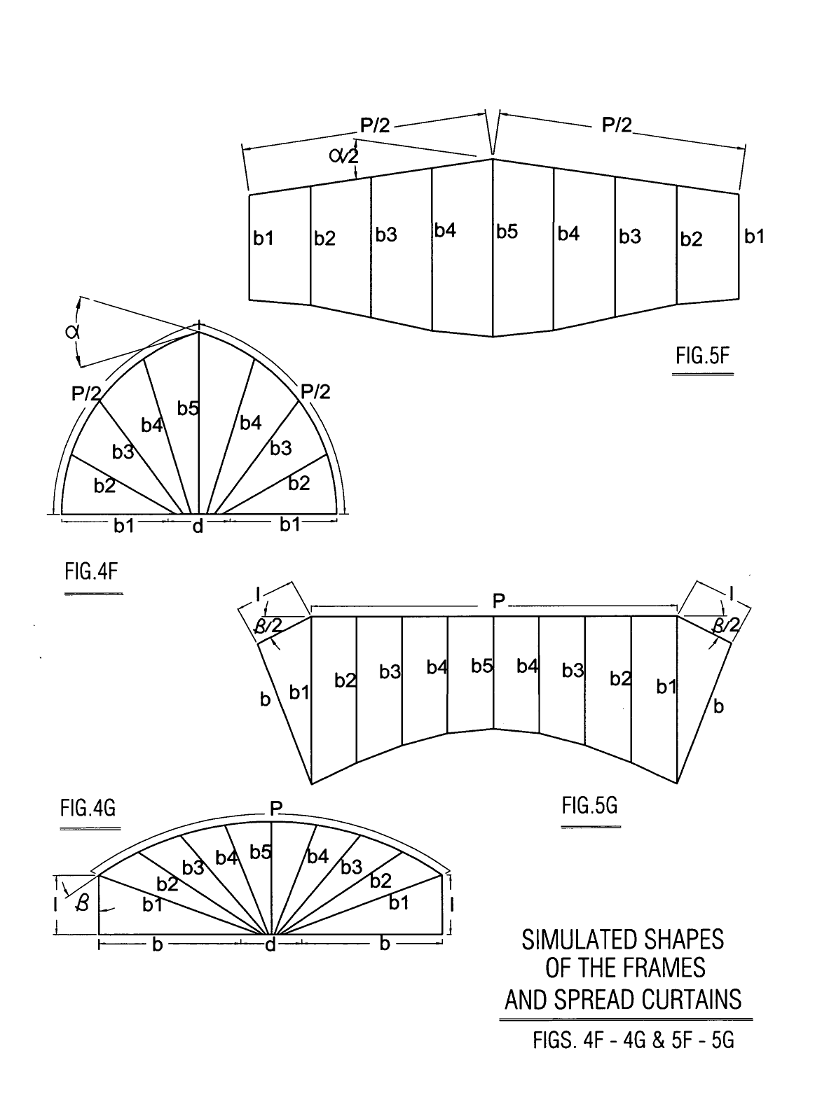

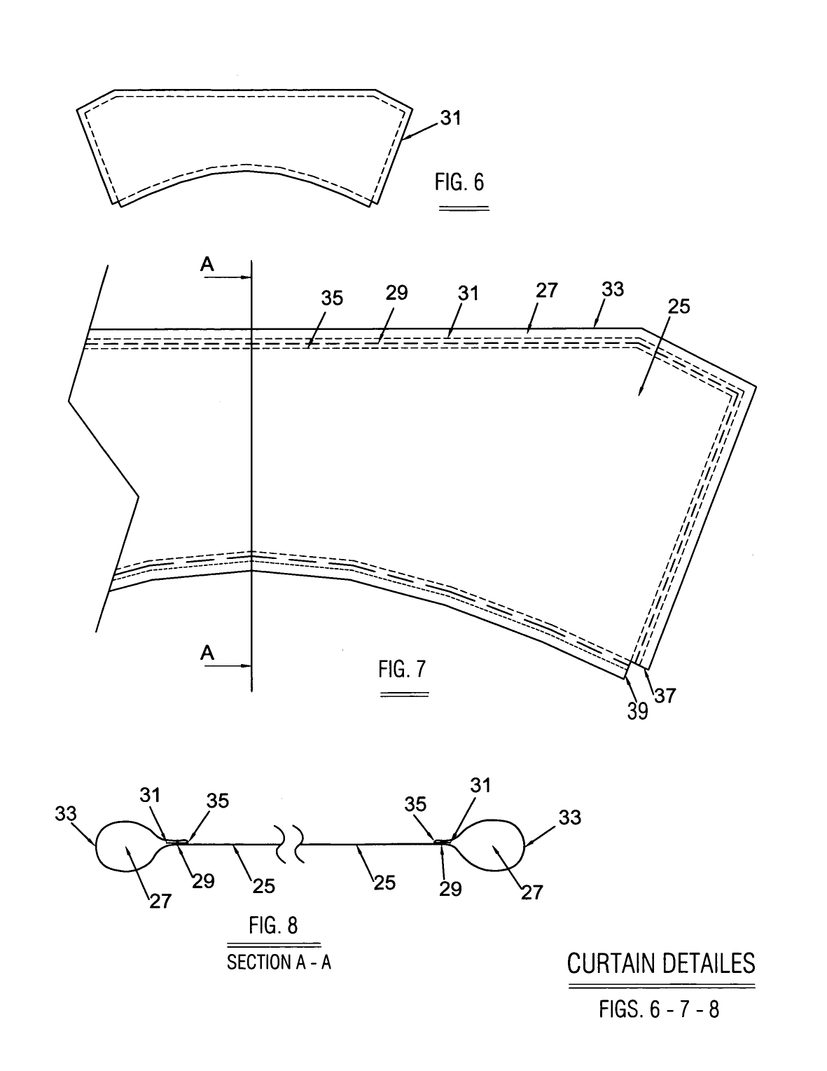

Following steps describe in detail how said method is rendered practicable:
a. measuring dimensions of an arched window frame precisely;
b. drawing a sketch of a window covering frame to fit into the window frame on a drawing table as shown in the FIGS. 4A to 4G. (The window covering frame should be slightly smaller than the mounting location of the window frame such that, if it is placed upon the window frame, leaves about ¼ inch on the sides);
c. marking the limits of the source of the creases of the curtain on said sketch with the length and location as already defined (FIGS. 4A to 4G);
d. dividing the length d of said source of the creases to an even number not less than 8, of equal divisions and mark them on the sketch;
e. dividing the length p of the curved portion or portions of the frame to the same number of divisions as that of the source of the creases and mark them on the sketch (FIGS. 4A to 4G);
f. drawing straight lines to connect each of said marked points of the crease source portion to the corresponding said marked points of the curved portion(s) of the sketch of the frame (FIGS. 4A to 4G);
g. measuring the lengths b1 to bn of said connecting lines, whereas b1 is the length of the lines connecting the first and the last marks on the crease source to the first and last marks on the curved portion(s) and bn is the length of the line at the middle;
h. measuring the refraction angles α of two curve segments of the sketch of the frame (in the case of the FIG. 4F) or β of one curve with its vertical sides (in the case of the FIG. 4G);
i. drawing a horizontal line with the length equal to the perimeter p of the curved portion(s) of the sketch of the frame (FIGS. 5A to 5G);
j. dividing said horizontal line into the same number of equal divisions as that of the crease source and marking the division points.
k. in the case of FIG. 4F, said horizontal line is bent from middle symmetrically downward until having a refraction angle α/2 as shown in the FIG. 5F;
l. drawing parallel vertical lines from said division points downward with the lengths b1 to bn as measured in the prior step “g” and in the same order;
m. in the cases of the composite shapes as the one shown in FIG. 4G, two inclined lines with the same length l of said short vertical sides of the sketch of the frame and refraction angle β/2 are connected to the both ends of said horizontal line and then two lines b are drawn to connect the free ends of said inclined lines to the ends of the lines b1 as shown in the FIG. 5G. (The length l of the short vertical sides are limited, because the angle between this lines and the lines b are not to fall under 90 degree);
n. drawing a curved line to connect the end points of said vertical parallel lines to enclose the shape as shown in the FIGS. 5A to 5G;
o. expanding said enclosed shape by about 1 inch from each side, whereas the expanded shape is a model for cutting a blank fabric (FIG. 6 as an example);
p. cutting the blank fabric according to the model;
q. folding and sewing the expanded portion of all edges of the cut fabric to form a curtain that has a passageway along the entire perimeter, whereas said passageway is slightly larger than the thickness of the rod of the frame as defined in the further step “s”. (According to the details shown in the FIGS. 7 and 8 as an example, the curtain has a body 25, passageway 27, stitching line 29, fabric edge 31, curtain outer edge 33 and curtain inner edge 35),
r. cutting the passageway 27 at the intersections of the curved side with the straight side(s) of the curtain to have two openings 37 and 39 at each intersection for entering the rod of the frame. (FIGS. 9A to 9G are the alternate shapes of the spread curtains of the window coverings 2A to 2G, showing various straight sides 24A, 24B, 24C, 24D, 24E, 24F, the curved side 24G, the openings 37 & 39, stitching lines 29 and curtain body 25);
s. bending a metal rod according to each of the sketches of the FIGS. 4A to 4G to form the Frame 26 of the window covering (FIGS. 3A to 3G). (The rod can be of normal steel with thickness of 3/16 inch for the frames with perimeter up to 12 feet and ¼ inch for larger frames, however a wooden rim is used to reinforce the edge of the base portion of the window covering, if necessary);
t. separating the crease holder 28 from curtain rod 30;
u. pulling while expanding the passageway of the straight side(s) of the curtain as constructed in the step “q” from the opening 37 of the passageway over the curtain rod, such that:
   straight side 24A or straight sides 24A and 24B of the curtain are attached to the corresponding curved portion 30A or curved portions 30A and 30B of the respective frame,
   straight sides 24C and 24D are attached to the portions 30C and 30D of the respective frame (the case of FIG. 9G),
   straight sides 24E and 24F are attached to the base portions 30E, and 30F of the respective frame (FIG. 11 is an example of such attachment);
v. entering one end of the crease holder 28 from the opening 39 into the passageway of the curved side 24G of the curtain and pulling over while gathering, until entirely pulled over and gathered.
w. connecting two ends 28-1 and 28-2 of the crease holder to the respective ends 30-1 and 30-2 of the curtain rod, using two flexible joints 32 as shown in the FIGS. 12 and 13. (Connecting joints 32 are two identical pieces of flexible tube with the preferred length 8 times of the diameter of the rod of the frame and the inner diameter slightly smaller than the diameter of the rod such that, inserting said ends of the rod into the connecting tubes need applying some force);
x. finally, adjusting and stitching the gathered fabric fixes the source of the creases of the curtain and the window covering of the present invention is created.

While preferred embodiment of the present invention and related method of construction has been described in detail, it is to be understood that modifications as are introduced hereunder may be applied:
1—The source of the creases of the curtain, in the cases of non full curved shapes can be chosen to be at the sides or other desired locations on the base of the frame.
2—Other types of connecting joints other than flexible tube (such as threaded coupling) can be used to connect two pieces of the frame together.
3—Any material with suitable bending and stiffness characteristics other than metal rod may be used to make said window covering frame.
4—Any suitable flexible material other than fabric may be used to make said curtain.
5—Total length of the passageways of the straight sides of the curtain as described above, is equal to the total length of the curtain rod, therefore creases that are originated over the crease holder are ended as are approaches the curtain rod, but said curtain may be designed to have longer length and as a result more bushy creases that are extended over the curtain rod.
6—A ruffle may be added along the perimeter of the curtain or an ornamental rim may be used to cover the edges of the window covering.

The preferred method of mounting a window covering of the present invention on the respective window, considering two important items:

1. easiness of mounting and dismounting;

2. not affecting the beauty of the curtain, window and wall around; is described hereunder:

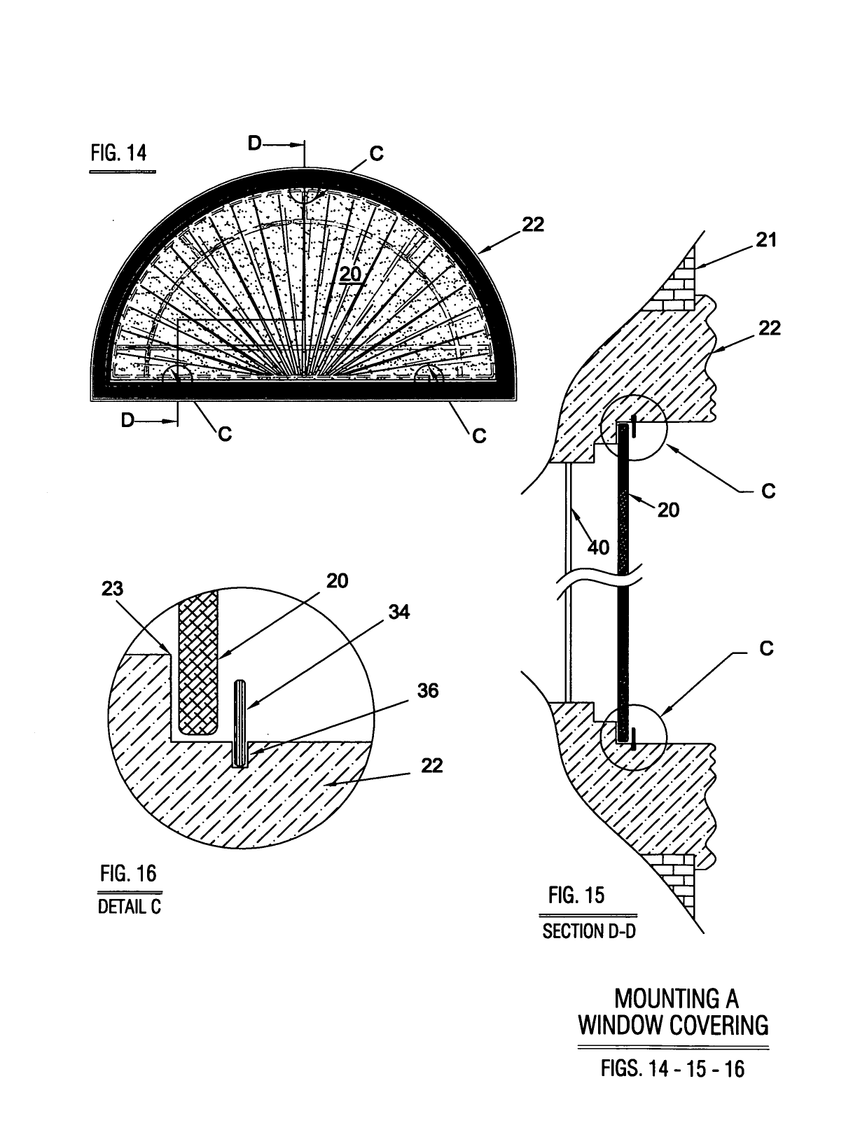

The preferred location for mounting a window covering 20 in relation to the window glass 40 is shown in the FIG. 15. The method as shown in the FIGS. 14, 15 and 16 consists of drilling holes 36 of ¼″ diameter and about ½″ depth on the inner surface of the window frame 22 at the points that are about ½″ far from the surface of the ring 23 of the window frame, said ring is used to supports the window covering 20 and the rims of the curtain leans on. Then common wooden multi-groove round Bits 34 of the size “¼″×1½″ that are commonly used by crafters are inserted into the said holes in front of the window covering to hold it at the place and keep it from falling. Said “Bits” that are now window covering holders are so small that can not affect the beauty of the window or the window covering and can be taken off when the curtain is not on the place. The number of the holes and window covering holders are 3 in the cases of non full curved and are 4 in the cases of full curved shapes and only the one at the top is to be fixed into the hole and does not need to be taken off when mounting or dismounting the window covering. FIG. 14 is a sample as the result of the described method.

I claim:

1- A window covering for an arched window of predefined shape, said window covering comprising:
a. a frame, constructed from a metal rod in two detachably connected parts, formed to the shape of the window; and
b. a curtain, constructed from one single piece of fabric having a passageway along all of the edges and pulled over said frame;
whereas a predefined side of said curtain is gathered over the smaller part that has predetermined length and located at the mid lower side of said frame, to form a source for creases of said window covering, where said creases are begun and extended towards the opposite sides of said frame where said creases are expanded over, wherein said curtain is continuous over the entire surface of the frame area.

2- A method for making a window covering to cover an arched window having predefined shape, wherein said predefined shape is a full circle or a full ellipsoid comprising the steps of:
a. drawing a sketch of a window covering frame to fit into the window frame on a drawing table, said sketch having full circular or full ellipsoidal shape;
b. defining and marking a portion at mid lower side of said sketch with a predetermined length, as source of the curtain creases;
c. dividing the length of said source of the curtain creases to an even number not less than 8, of equal divisions and mark them on said sketch;
d. dividing the length of the rest curved portion of said sketch to the same number of equal divisions as that of the crease source portion and mark them on said sketch;
e. drawing straight lines to connect each of said marked points of said crease source portion to the corresponding marked points of said rest curved portion;
f. measuring the length of each of the connecting lines;
g. drawing a horizontal line with the length equal to the length of said rest curved portion;
h. dividing said horizontal line into the same number of divisions as that of said crease source portion and marking the division points;
i. drawing parallel vertical lines from said division points with the lengths as measured and in the same order;
j. drawing a curved line to connect the end points of said parallel vertical lines to obtain an enclosed area;
k. expanding said enclosed area by certain amount from each side, whereas the expanded shape is a model for cutting a blank fabric;
l. cutting the blank fabric according to said model;
m. folding and sewing the expanded portion of all edges of the cut fabric to form a curtain that has a passageway of certain diameter along the entire perimeter;
n. bending a metal rod with predefined thickness, according to said sketch to form the frame of the window covering;
o. separating a section with the same length and location of the crease source portion from said frame, said section is referred to as crease holder and the rest section is referred to as curtain rod;
p. pulling while expanding the passageway of the straight side of said curtain over said curtain rod;
q. pulling while gathering the passageway of the curved side of said curtain over said crease holder;
r. connecting two ends of said crease holder to the respective ends of said curtain rod using two pieces of flexible tube to enclose the frame; and
s. stitching the gathered fabric to fix said crease source and to form a complete window covering.

3- The method of claim 2, wherein said method is applied to an arched window having a shape as a segment of a circle or a segment of a ellipsoid, comprising the steps of:
a. drawing a sketch of a window covering frame to fit into the window frame on a drawing table, said sketch having a segment of circle or a segment of ellipsoid and base portions;
b. defining and marking a portion at mid lower side of said sketch with a predetermined length, as source of the curtain creases;
c. dividing the length of said source of the curtain creases to an even number not less than 8, of equal divisions and mark them on said sketch;
d. dividing the length of the curved portion of said sketch to the same number of equal divisions as that of the crease source portion and mark them on the sketch;
e. drawing straight lines to connect each of said marked points of said crease source portion to the corresponding marked points of said curved portion;
f. measuring the length of each of the connecting lines;
g. drawing a horizontal line with the length equal to the length of said curved portion;
h. dividing said horizontal line into the same number of divisions as that of crease source portion and marking the division points;
i. drawing parallel vertical lines from said division points with the lengths as measured and in the same order;
j. drawing a curved line to connect the end points of the said parallel vertical lines to obtain an enclosed area;
k. expanding said enclosed area by certain amount from each side, whereas the expanded shape is a model for cutting a blank fabric;
l. cutting the blank fabric according to said model;
m. folding and sewing the expanded portion of all edges of the cut fabric to form a curtain that has a passageway of certain diameter along the entire perimeter;
n. bending a metal rod with predefined thickness, according to said sketch to form the frame of the window covering;
o. separating a section with the same length and location of the crease source portion from said frame, said section is referred to as crease holder and the rest section is referred to as curtain rod;
p. pulling while expanding the passageway of the straight sides of said curtain over said curtain rod;
q. pulling while gathering the passageway of the curved side of said curtain over said crease holder;
r. connecting two ends of said crease holder to the respective ends of said curtain rod using two pieces of flexible tube to enclose the frame; and
s. stitching the gathered fabric to fix said crease source and to form a complete window covering.

4- The method of claim 2, wherein said method is applied to an arched window having a shape composed of two connected curved segments, comprising the steps of:
a. drawing a sketch of a window covering frame to fit into the window frame on a drawing table, said sketch having two connected curves with certain refraction angle and base portions;
b. defining and marking a portion at mid lower side of said sketch with a predetermined length, as source of the curtain creases;
c. dividing the length of said source of the curtain creases to an even number not less than 8, of equal divisions and mark them on the sketch;
d. dividing the length of the two connected curved portions of said sketch totally to the same number of equal divisions as that of the crease source portion and mark them on the sketch;
e. drawing straight lines to connect each of said marked points of said crease source portion to the corresponding marked points of said two curved portions;
f. measuring the length of each of the connecting lines;
g. measuring the refraction angle of one curved portion toward the next;
h. drawing a horizontal line with the length equal to the total length of said two connected curved portions;
i. dividing said horizontal line into the same number of divisions as that of said crease source portion and marking the division points;
j. bending said horizontal line from middle symmetrically downward until having a refraction angle equal to half of the measured refraction angle of said two curved portions;
k. drawing parallel vertical lines from said division points downward with the lengths as measured and in the same order;
l. drawing a curved line to connect the end points of said parallel vertical lines to obtain an enclosed area;
m. expanding said enclosed area by certain amount from each side, whereas the expanded shape is a model for cutting a blank fabric;
n. cutting the blank fabric according to said model;
o. folding and sewing the expanded portion of all edges of the cut fabric to form a curtain that has a passageway of certain diameter along the entire perimeter;
p. bending a metal rod with predefined thickness, according to said sketch to form the frame of the window covering;
q. separating a section with the same length and location of the crease source portion from said frame, said section is referred to as crease holder and the rest section is referred to as curtain rod;
r. pulling while expanding the passageway of the straight sides of said curtain over said curtain rod;
s. pulling while gathering the passageway of the curved side of said curtain over said crease holder;
t. connecting two ends of said crease holder to the respective ends of said curtain rod using two pieces of flexible tube to enclose the frame; and
u. stitching the gathered fabric to fix said crease source and to form a complete window covering.

5- The method of claim 2, wherein said method is applied to an arched window having a shape composed of one upper curved segment followed by two short vertical sides of predefined length, comprising the steps of:
a. drawing a sketch of a window covering frame to fit into the window frame on a drawing table, said sketch having a curved portion at the upper side, two vertical sides of predefined length and base portions and also defining a refraction angle between said curved portion and each of said vertical sides;
b. defining and marking a portion at mid lower side of said sketch with a predetermined length, as source of the curtain creases;
c. dividing the length of said source of the curtain creases to an even number not less than 8, of equal divisions and mark them on said sketch;
d. dividing the length of said curved portion of said sketch to the same number of divisions as that of the crease source portion and mark them on said sketch;
e. drawing straight lines to connect each of said marked points of the crease source portion to the corresponding marked points of said curved portion;
f. measuring the length of each of the connecting lines;
g. measuring the refraction angle of said curved portion toward said vertical sides;
h. drawing a horizontal line with the length equal to the length of said curved portion;
i. dividing said horizontal line into the same number of divisions as that of said crease source portion and marking the division points;
j. drawing parallel vertical lines from said division points downward with the lengths as measured and in the same order;
k. drawing a curved line to connect the end points of said parallel vertical lines;
l. connecting two inclined lines with the same length of said vertical sides of said sketch to the ends of said horizontal line, with refraction angle equal to half of the measured refraction angle;
m. drawing two straight lines to connect the free ends of said inclined lines to the respective ends of said curved line to obtain an enclosed area;
n. expanding said enclosed area by certain amount from each side, whereas the expanded shape is a model for cutting a blank fabric;
o. cutting the blank fabric according to said model;
p. folding and sewing the expanded portion of all edges of the cut fabric to form a curtain that has a passageway of certain diameter along the entire perimeter;
q. bending a metal rod with predefined thickness, according to said sketch to form the frame of the window covering;
r. separating a section with the same length and location of the crease source portion from said frame, said sections referred to as crease holder and the rest section is referred to as curtain rod;
s. pulling while expanding the passageway of the straight sides of the curtain over said curtain rod;
t. pulling while gathering the passageway of the curved side of said curtain over said crease holder;
u. connecting two ends of said crease holder to the respective ends of said curtain rod using two pieces of flexible tube to enclose the frame; and
v. stitching the gathered fabric to fix said crease source and to form a complete window covering.

6- The window covering of claim 1, 2, 3, 4, or 5, wherein said curtain is designed to have a length bigger than perimeter of the curved portions of the frame, in order to have more bushy creases.

7- The window covering of claim 1, 2, 3, 4, or 5, wherein a ruffle is added along the perimeter of said curtain.

8- The window covering of claim 1, 2, 3, 4, or 5, wherein an ornamental rim is used to cover the edges of said window covering.

9- The window covering of claim 1, 3, 4, or 5, wherein the position of said crease source is moved to one side of the base of said frame.

10- The window covering of claim 1, 2, 3, 4, or 5, wherein a flexible material other than fabric is used to make said curtain.

11- The window covering of claim 1, 2, 3, 4, or 5, wherein said frame is constructed from any other material of suitable bending and stiffness characteristics.
